(19) United States
(12) Patent Application Publication
(10) Pub. No.: US 2009/0163072 A1
(43) Pub. Date: Jun. 25, 2009

(54) PLUG CONNECTOR

(75) Inventors: Tobias Schimmele-Brell, Weinstadt (DE); Andreas Michael Schremmer, Berglen (DE); Helmut Singer, Bad Ditzenbach (DE); Gerhard Werder, Althutte (DE); Andreas Wolfgang Wyderka, Korb (DE); Gerald Taxis, Schorndorf/Miedelsbach (DE); Egon Sigle, Weinstadt (DE)

Correspondence Address: LEON D. ROSEN;FREILICH, HORNBAKER & ROSEN, Suite 1220, 10960 Wilshire Blvd., Los Angeles, CA, 90024, US

(73) Assignee: ITT Manufacturing Enterprises. Inc.

(21) Appl. No.: 12/332,126

(22) Filed: Dec. 10, 2008

(30) Foreign Application Priority Data
Dec. 20, 2007 (DE) 10 2007 063 207.1

(51) Int. Cl. H01R 13/627

(52) U.S. Cl. 439/357

(57) ABSTRACT

A plug connector (11, 12, FIG. 1) has insulators (16,26) that hold male or female contacts (13, 14, FIG. 3) received in boreholes (19, 29, FIGS. 4A, 4B)). A rear insulator holds a male or female contact (13, 14), which receives cables (45, 55, FIG. 3). The boreholes (19, 29) form fingers (78, 98, FIGS. 4A and 6) that can be radially spread apart to detachably hold the connector contacts (13, 14) in a preliminary locking manner. The plug connector also has a front insert (60, 80) with a front borehole (65, 85) aligned with the rear boreholes (19, 29) and being able to be placed in a non-detachable preliminary locking position that makes possible the attachment of the connector contacts (13, 14) and in a final locking position that holds the connector contacts (13, 14) in a non-releasable fashion.

### CROSS-REFERENCE TO RELATED APPLICATION

Applicant claims priority from German patent application no. 10 2007 063 207.1 filed Dec. 20, 2007.

### BACKGROUND OF THE INVENTION

The present invention relates to a plug connector. By way of example, it is known from DE 10 2006 016 82 A1 to provide a plug connector with two latches for the connector contacts, whereby the first latch results in a non-detachable connection of the connector contacts with the insulating member, whereas the second latch functions to ensure that all the connector contacts are set in the prescribed, correct position via the first latch.

In particular, in the case of plug connections that can be joined to a multiplicity of connector contacts, it is desirable that the customer himself see to the placement in the plug connectors of connector contacts that are already provided with cables. In this context, it seems to be necessary that said placement initially occur through a preliminary locking step, which in the event of errors occurring in the placement can be modified without difficulty, by being able to separate the connector contacts in question once again from the preliminary locking position. A final locking of the connector contacts is then only achieved when components are correctly placed in the preliminary locking position. A plug connector of this type, as indicated in the preamble of Claim 1, has already been proposed and used. In this context, the front end of the insulating member receives an insert which can change the preliminary locking position to a final locking position, in which the connector contacts can no longer be separated from the insulating member. In this context, although the insert is designed to be able to be moved once again with respect to the insulating member so that it is possible to return to the preliminary locking position in order to correct faulty placement results, nevertheless this has turned out to be possible only at significant expense, it is impeded by the cables that are connected to the connector contacts, and it cannot be accomplished without destruction in all cases.

The objective of the present invention is therefore to indicate a plug connector of the aforementioned type, in which even after the final locking position is achieved it is possible without difficulty to return to the preliminary locking position, permitting components to once again be placed, without great expense and without being impeded by the cables.

### SUMMARY OF THE INVENTION

As a result of the measures according to the present invention, it is achieved that the insert, from the front end of the insulating member, i.e., without being impeded by the cables that have already been inserted into the insulating member, can be returned from a final locking position to its preliminary locking position, with no element being destroyed. The plug connector is configured so that this type of return is possible multiple times, from the final locking position to the preliminary locking position, and vice versa.

An advantageous design for achieving this emerges from the features according to Claim 2. In this way, it is possible in a simple manner to engage the final locking hooks of the insert from the outside and therefore to reliably unlock them.

Advantageous embodiments for this purpose emerge from the features of one or more of Claims 3 to 5.

Advantageous embodiments with respect to the design arrangement of the preliminary-locking cams, on the one hand, and the final locking hooks, on the other hand, emerge from the features of one or more of Claims 6 to 8.

The features in accordance with Claim 9 and, as appropriate, those of Claim 10 assure a simple design of the locking mechanism of the preliminary-locking fingers in an insert that has been slid into its final position, whereby a locking cone or taper is advantageously employed.

With respect to sealing the plug connector made up of a male and a female connector from the outside, advantageous embodiments emerge from the features of Claim 11 and/or 12.

One preferred embodiment of the connector contacts emerges from the features of Claim 13, whereby in accordance with the features of Claim 14 a seal is achieved from the rear side of male or female connectors in the direction of the connector contacts.

Further details of the invention may be derived from the following description, in which the invention is described and explained in greater detail on the basis of the exemplary embodiments shown in the drawing.

### DESCRIPTION OF THE DRAWINGS

FIG. 1 is an exploded isometric view of a first plug connector having male connector contacts, and of a second plug connector having female connector contacts of a plug connector device, in accordance with one preferred exemplary embodiment of the present invention.

FIG. 2 is an exploded isometric view of the first male connector of FIG. 1.

FIG. 3A is a side elevation view of a male contact of the first male connector of FIG. 1.

FIG. 3B is a side elevation view of a female contact of the second female connector of FIG. 1.

FIG. 4A is an isometric sectional view of the first male connector of FIG. 1 in a preliminary locking position.

FIG. 4B is an isometric section view similar to FIG. 4A but with a male connector in a final locking position.

FIG. 5 is an exploded isometric view of the second plug connector of FIG. 1B.

FIG. 6 is an isometric sectional view of the second plug connector of FIG. 1 shown in final locking position.

FIG. 7 is a front elevation view of the connector of FIG. 4A.

FIG. 8 is a front elevation view of the connector of FIG. 4B.

### DESCRIPTION OF THE INVENTION

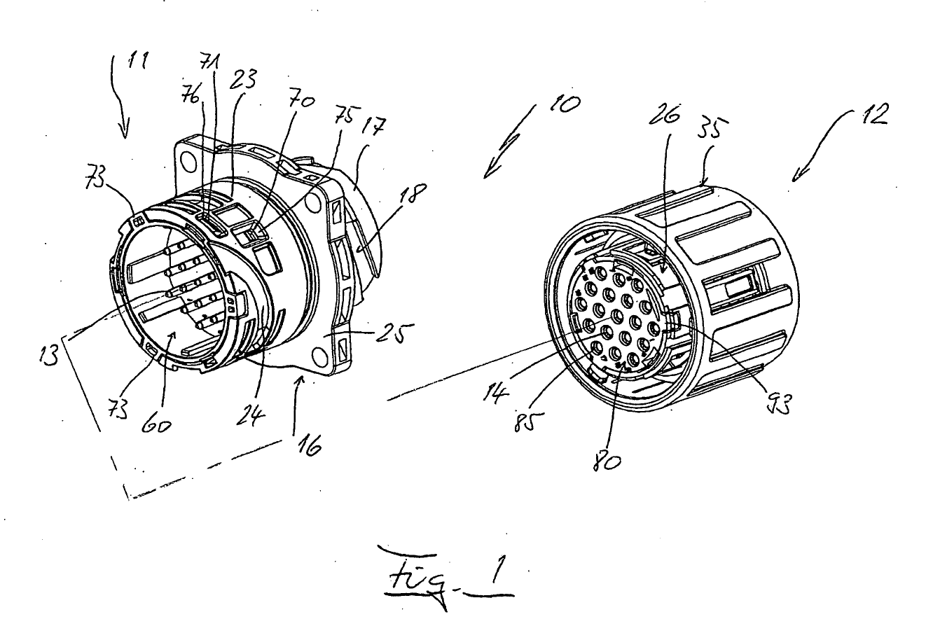

Plug connector device 10, as depicted in the drawing, is made up of a first plug connector 11 having male connector contacts 13 in accordance with FIG. 1A, and a second, or counter, plug connector 12 having female connector contacts 14 in accordance with FIG. 1B. Both plug connectors 11 and 12 in the exemplary embodiment are designed as having 19 poles (contacts), whereby connector contacts 13 and 14 are arranged so as to be uniformly distributed above and next to each other over a surface that is round when seen in a frontal view.

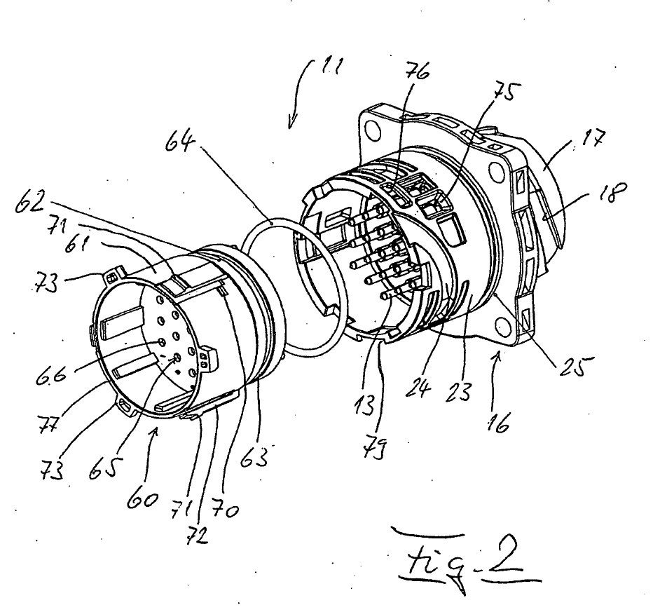

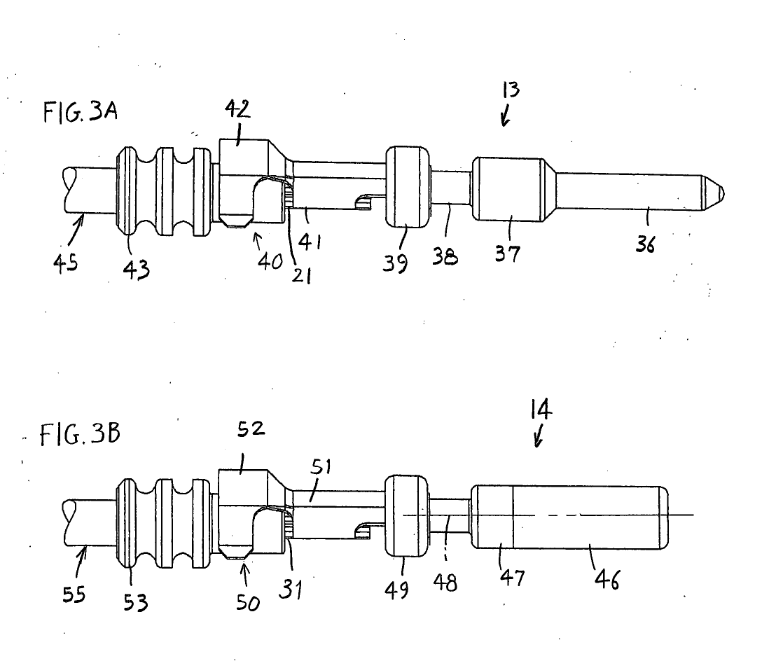

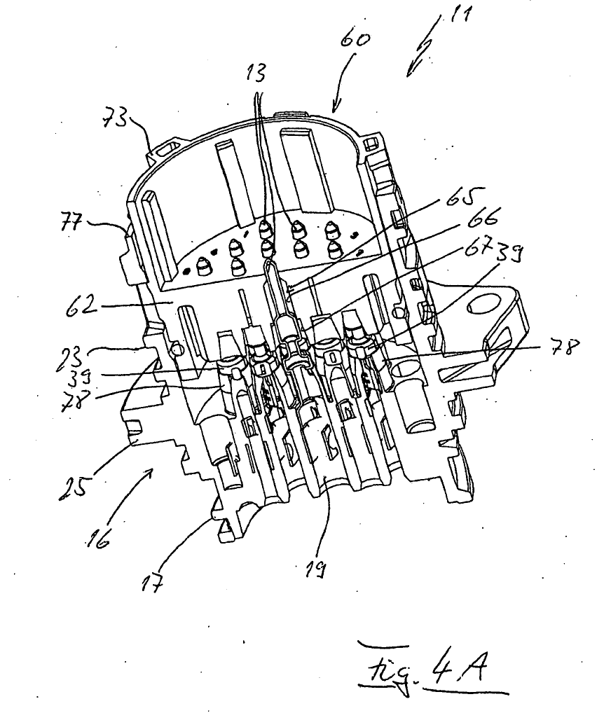

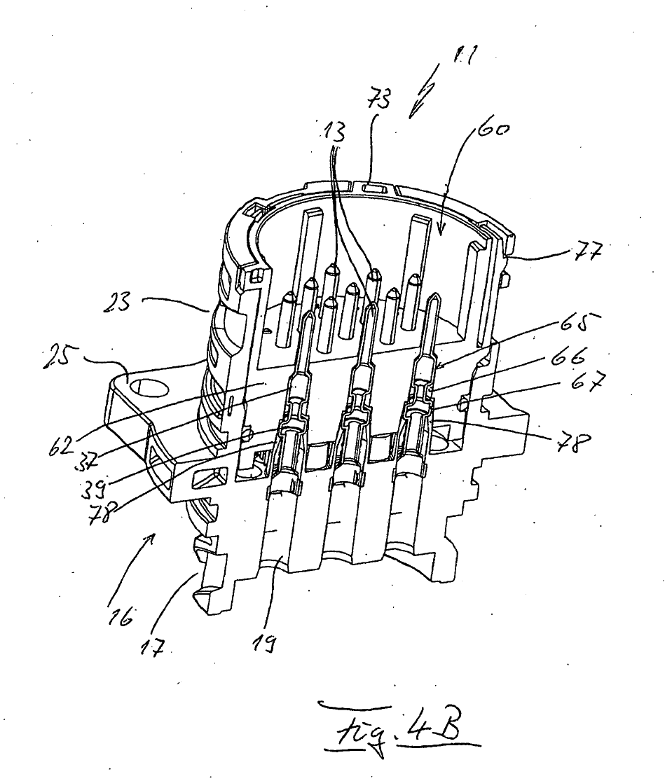

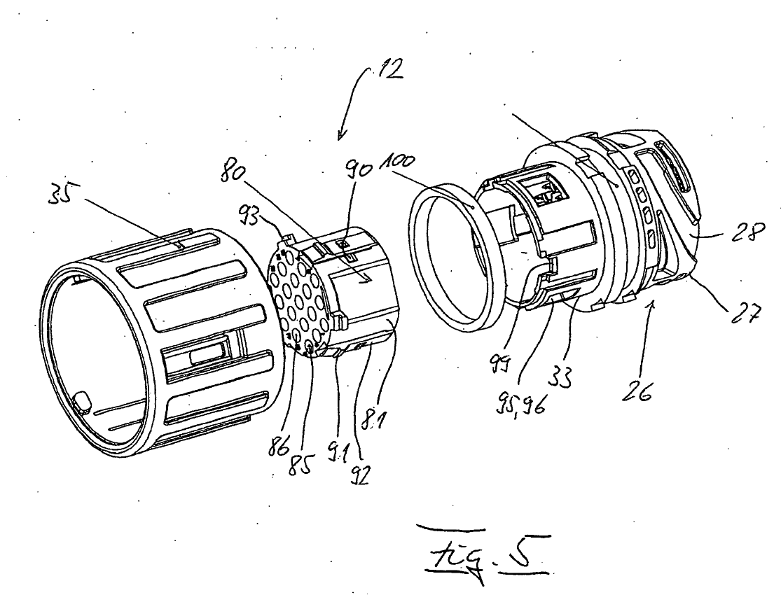

First plug connector 11 (FIGS. 1A and 2) contains an insulating housing 16, whose rear end 17 on the exterior periphery is provided with bayonet-type grooves 18 for a longitudinal sleeve of a bunched cable and on the interior side with a multiplicity of through boreholes 19 (FIGS. 4A and 4B), into which male connector contacts 13, each of which is provided with an individual cable core 21 (FIG. 3A), are inserted. Front end 23 (FIG. 1) of insulating housing 16 is configured as a female piece, thus as a hollow cylinder, and also possesses around its exterior periphery bayonet-type grooves 24 for a coupling nut 35 of counter plug connector 12. Between rear end 17 and front end 23 of single-piece insulating housing 16, an attachment plate 25 is provided in the exemplary embodiment for installation and mounting on a device wall or the like.

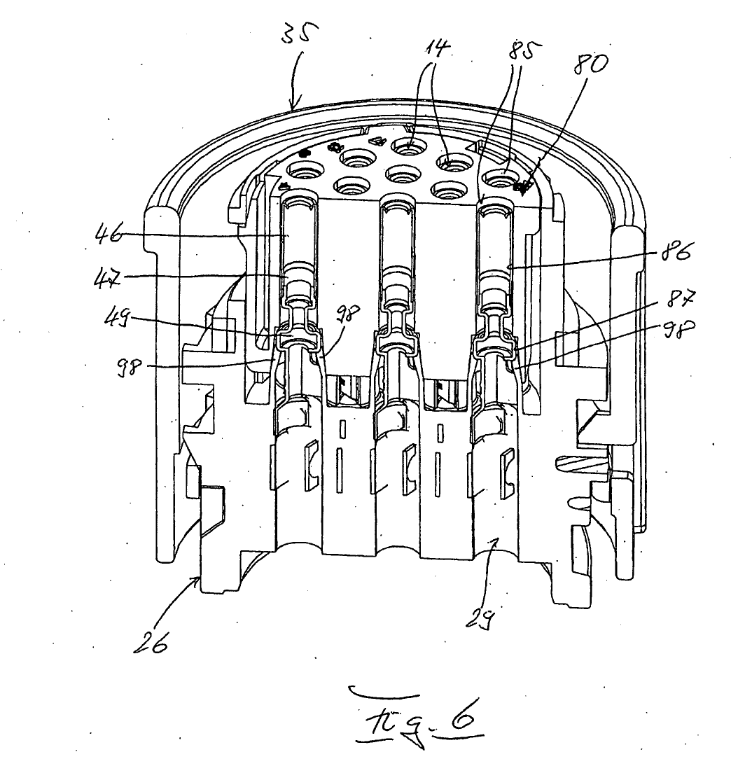

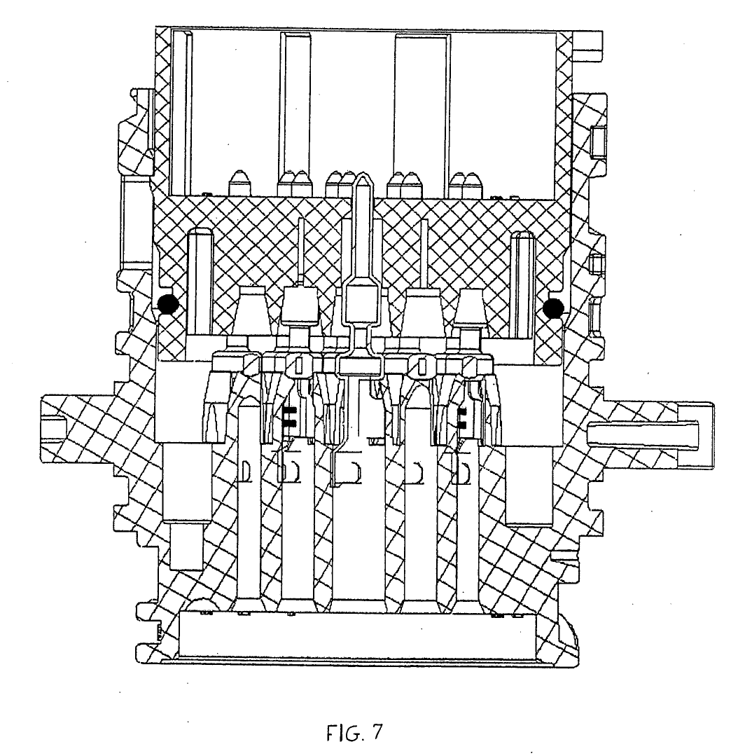

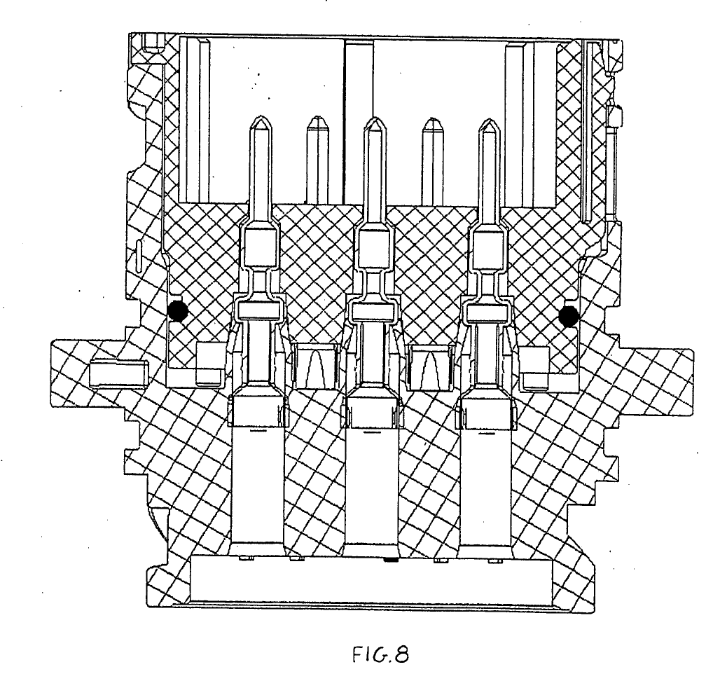

Second plug connector 12 (FIGS. 1B and 5) also contains an insulating housing 26, whose rear end 27 on its exterior periphery is provided with bayonet-type grooves 28 for a bunched cable sleeve and on its interior side is also provided with axial through boreholes 29 (FIG. 6) that are arranged so as to be uniformly distributed on a circular surface when seen from a top view, in order to insert female connector contacts 14, which are provided with cable cores 31 (FIG. 3B). Front end 33 (FIG. 5) of insulating housing 26 is configured as a hollow cylinder and functions as the male piece to allow it to be inserted into female piece 23 (FIG. 1) of insulating housing 16 of plug connector 11 so as to achieve a plug connection. Supported above or around insulating housing 26 is coupling nut 35, which is supported so as to be axially fixed although rotatable and which functions to hold both plug connectors 11 and 12 together and to draw them towards each other in a plug connection.

Before turning specifically to the providing of plug connectors 11 and 12, and their insulating housings 16 and 26 with either male connector contacts 13 or female connector contacts 14, including their cable cores 21 and 31, male and female connector contacts 13 and 14 of this type will be described on the basis of FIGS. 3A and 3B.

Male connector contact 13 in accordance with FIG. 3A has a male end 36 having a guiding collar 37, which via an intermediate piece 38 that has a smaller diameter passes into a detent collar 39, whose exterior diameter is greater than the exterior diameter of guiding collar 37. Whereas segments 36 to 39 coaxially fit into one another so as to form a single piece, a crimping segment 40 eccentrically contacts detent collar 39, whose first connecting end 41 surrounds core 21, or the braided wire of a cable 45, so as to be mechanically crimped in such a way that it is fixed, and whose second connecting end 42 tightly holds an area of a sealing lip 43, which is pushed over the insulation of cable 45.

In a female connector contact 32 according to FIG. 3B, a hollow cylindrical, female end 46 forms an integral part with a guiding collar 47, whereby female end 46 and guiding collar 47 have the same exterior diameter. Connected to guiding collar 47 is an intermediate piece 48 of a smaller diameter which passes over into a detent collar 49, whose exterior diameter is greater than the exterior diameter of female end 46 and guiding collar 47. Connected in an eccentric manner to detent collar 49 is once again a crimping segment 50, whose first connecting end 51 mechanically holds insulated core 31 of a cable 55, so that said core is fixedly crimped and electrically connected, and whose second connecting end 52 axially holds a sealing lip 53 over the insulation of cable 55.

In accordance with FIG. 2, first plug connector 11 has an insulating insert 60, which it is possible to axially slide, or insert, into front, female end 23 of insulating housing 16 to achieve a preliminary locking and a final locking of male connector contacts 13 in insulating housing 16 in two different axial positions. Insulating insert 60 has a locking cylinder 61 having a relatively thick base 62, which around the exterior periphery supports a sealing ring 64, for example in the form of an O-ring, in a groove 63. Base 62 is provided in the axial direction with stepped through boreholes 65, which are uniformly distributed over its surface and whose borehole segments 66, proceeding from within locking cylinders 61, have a smaller diameter than borehole segments 67 (FIGS. 4A and 4B), which are facing male connector contacts 22 and which have a conical form that tapers from outside to inside.

Around the exterior periphery, locking cylinder 61 (FIG. 2) is provided with three locking cams 70 and locking hooks 71 which are uniformly distributed over the periphery. Locking cams 70 and locking hooks 71 are spaced both in the circumferential direction as well as in the axial direction.

Locking cams 70 determine, or border, a preliminary locking position of insulating insert 60 within front female end 23 of insulating housing 16 for the insertion of male connector contacts 13 to the preliminary locking position. Locking hooks. 71 determine, or border, the final locking position of insulating insert 60 in front female end 23 of insulating housing 16. In the final locking position, male connector contacts which had been in the preliminary locking position are fixed in their non-detachable position with respect to insulating housing 16. The axial distance between locking cams 70 and locking hooks 71 determines the axial path between the preliminary locking position and the final locking position of insulating insert 60 within front female end 23 of insulating housing 16.

Whereas locking cams 70 (FIG. 2) are molded on the exterior periphery of locking cylinders 61 in the vicinity of base 62 so as to project radially in a direct manner, locking hooks 71 are each molded so as to protrude radially in the vicinity of the free end of a spring-acting bar 72, which at its end faces away from locking hook 71 is connected to the exterior periphery of locking cylinder 61. To provide for the possibility of a radial motion of bar 72 and therefore of locking hook 71, the wall of locking cylinder 61 is configured so as to be recessed in the area of bar 72. Of the three bars 72, arranged over the periphery of the locking cylinder, one of them is configured so as to be narrower in order to provide for assembly coding. At the free end edge 77 of locking cylinder 61, three radially protruding ears 73, arranged uniformly over the periphery, are provided for the sake of the non-rotating fixation of insulating insert 60 in end-face recesses 79 of insulating housing 16 (FIG. 1A).

Front female end 23 of insulating housing 16, to receive bars 72 that are provided with locking hooks 71, has corresponding axial grooves in the wall on the interior periphery and windows 75 and 76, uniformly distributed over the periphery, for locking cams 70 and locking hooks 71, as counter locks in the wall of front female end 23 of insulating housing 16.

Windows 75 and 76 are spaced both on the periphery as well as axially. Whereas windows 75, to permit locking cams 70 to be axially received in a movable manner, are configured so as to be longitudinal in the axial direction, windows 76 for receiving locking hooks 71 are dimensioned so that in the locking position no substantial axial play is permitted for locking hooks 71 within windows 76.

FIGS. 4A and 4B depict the two different positions of insulating insert 60 within insulating housing 16, whereby in the preliminary locking position male connector contacts 13, which are provided with cores 21 (FIG. 3A), are inserted into insulating housing 16 (FIG. 1) from rear end 17 to achieve the preliminary locking position, and they can be removed and once again inserted in the event of a faulty placement. This position is shown in FIG. 4A, in which locking cams 70 are located within window 75, whereas locking hooks 71 are still located axially in front of end face 77 of front female end 23 of insulating housing 16. As depicted, through boreholes 19 within rear end 17 of insulating housing 16 at their exiting end are extended into female end 23 by means of three locking fingers 78, which are arranged so as to be distributed on the periphery of through boreholes 19 and whose interior clearance tapers in conical fashion towards their free ends. Locking fingers 78 have a cylindrical base and a segment, connected thereto, that tapers in conical fashion at the exterior periphery. When a male connector contact 13 is inserted, locking fingers 78 expand due to their detent collars 39, whereby the free ends of locking fingers 78 spring back once again after being released by detent collar 39, so that their free end faces engage behind detent collar 39. The expansion elasticity of locking fingers 78 as well as any contouring at their locking end face make it possible for locking fingers 78 to release male connector contact 13 by overcoming a radial clamping pressure once said contact is withdrawn by core 21 (FIG. 3A). Thus in the preliminary locking position of insulating insert 60 within insulating housing 16, the placement of insulating housing 16 having male connector contacts 13 can be changed at any time.

FIG. 4B indicates the so-called final locking position of insulating insert 60 within insulating housing 16, in which locking hooks 71 of insulating insert 60 are positioned in windows 76 of front female end 23 of insulating housing 16. In this position, borehole segments 76 of stepped through boreholes 65 within base 62 of insulating insert 60, which have a larger diameter and are conical, are axially moved to the inside over detent collars 39 of male connector contacts 13 and over partially conical locking fingers 78. In this way, each larger-diameter borehole segment 67 surrounds locking finger 78 without significant play, such that a radial expansion of locking finger 78 and therefore a withdrawal and removal of male connector contact 13 by means of core 21 is prevented. In this way, detent collars 39 of male connector contacts 22 are held without significant play between the end face of locking fingers 78 and the shoulder in the area between both borehole segments 67 and 66 of stepped through boreholes 65 within insulating insert 60.

It is possible without using an un-depicted tool to radially move locking hooks 71, which are held at elastic bars 72, to the inside from the exterior periphery side of insulating insert 60 through windows 76, in such a way that it is possible to unlock insulating insert 60 within insulating housing 16 and therefore to cause an axial reverse motion of insulating insert 60 from insulating housing 16. This axial reverse motion, however, can only occur up to the locking limit stop of locking cams 70 (FIG. 2) at the transverse border of window 75, i.e., from the final locking position to the preliminary locking position, in which latter position once again it is possible to alter the placement.

According to FIG. 5, second plug connector 12, i.e., the counter plug connector, has an insulating insert 80, which can be inserted into front male plug end 33 of insulating housing 26 with the same goal and purpose and in the same locking positions, namely in a preliminary locking position and in a final locking position. Insulating insert 80, as also depicted in FIG. 6, has an essentially cylindrical locking block 81, which is provided with stepped through boreholes 85, which from the point of view of the end face are uniformly distributed, and which have axially longer borehole segments 86, having a smaller diameter, and axially shorter borehole segments 87, having a larger diameter and a conical form that tapers from the outside to the inside. Around the exterior periphery, insulating insert 80 also has fixed locking cams 90 and radially movable locking hooks 91 on elastic bars 92. In this context, the configuration of locking cams 90 and locking hooks 91, including bars 92, is essentially identical to that of locking cams 70, locking hooks 71, and bars 72.

In addition, one end of insulating insert 80 has ears 93 molded so as to radially protrude to the outside. Insulating insert 80 is accommodated within insulating housing 26 in the same way as insulating insert 60 within insulating housing 16. In other words, front male plug end 33 of insulating housing 26 is also provided with axial grooves 90 for bars 92 and with windows 95 and 96 for locking cams 90 and locking hooks 91. Ears 93 in the final locking position of insulating insert 80 within insulating housing 26 are positioned within end-face recesses 99 to ensure the non-rotatability of insulating insert 80 within front male plug end 33 of insulating housing 26.

FIG. 6 depicts the final locking position of insulating insert 80 within insulating housing 26, which corresponds to the aforementioned final locking position of insulating insert 60 within insulating housing 16. This also applies to the preliminary locking position of insulating insert 80 within insulating housing 26. The insertion of female connector contacts 14 into rear end 27 of insulating housing 26 is carried out in the same way as the insertion of male connector contacts 13 into rear end 17 of insulating housing 16. In addition, through boreholes 29 within insulating housing 26 are axially extended by expandable locking fingers 98, so that they carry out the preliminary-locking function for detent collars 49 of inserted female connector contacts 14, and they do so as long as insulating insert 80 is arranged in its preliminary locking position within insulating housing 26. According to FIG. 6, in the final locking position of insulating insert 80, locking fingers 78, which to the outside are partially conical or cone shaped, are overlapped by larger-diameter borehole segments 87, which are partially conical as they extend forward, of stepped through boreholes 85 of insulating insert 80, so that detent collar 49 of female connector contacts 14 is held between locking fingers 98 and the shoulder in the area between borehole segments 86 and 87.

In this second plug connector 12, it is also possible to use a tool to return insulating insert 80 from the final locking position to the preliminary locking position by radially pressing and therefore unlocking bars 92 (FIG. 5), which are provided with locking hooks 91, so that a change in the placement of second plug connector 12 having female connector contacts 32 is possible. As can be seen from FIG. 1B, this is possible here due to the radial distance between the interior periphery of coupling nut 35 and the exterior periphery of front plug end 33 of insulating housing 26, seen from this front end.

Using coupling nut 35, which has bayonet-like interior projections that are not depicted in detail, it is possible to pull both plug connectors 11 and 12 towards each other, by screwing coupling nut 35 onto front female end 23 of insulating housing 16 like a bayonet. In this way, an annular seal 100 (FIG. 5), which is arranged around the exterior periphery over front plug end 33 of insulating housing 26 and which contacts a collar of insulating housing 26, is clamped between this collar and the end face of front female end 23 of insulating housing 16.

In the case of a 19-pole plug connector in accordance with the depicted exemplary embodiment, it is obvious that plug connectors having greater or lesser numbers of poles can be executed. In addition, in the case of such plug connectors it is also possible to mix thicker power-contact elements and thinner signal-contact elements, because the two locking positions are identical. In addition, by modifying insert 60 to 80, it is also possible to transform a plug connector 11 having male connector contacts 13 into one having female connector contacts 14 within the same insulating housing 16, and back again. In the case of an appropriate modification of insert 60 or 80, a mixture of male and female connector contacts 13, 14 would also be possible.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A plug connector (11, 12), having an insulating member (16, 26), in which electrical male and female connector contacts (13, 14) are accommodated in receiving boreholes (19, 29) next to each other and which at one front end is configured as a male piece (23) or female piece (33) and at the rear end is configured for the locking insertion of the male or female connector contacts (13, 14), which are provided with a cable (45, 55), into the insulating member (16, 26), wherein:
the receiving boreholes (19, 29) are axially extendable by fingers (78, 98) that can be spread apart radially in order to detachably hold the connector contacts (13, 14) in a preliminary-locking manner, said plug connector also having an insert (60, 80), which can be inserted into the front end (23, 33) of the insulating member (16, 26), and which has through boreholes (65, 85) that are flush with the receiving boreholes (19, 29) within the insulating member (16, 26), said insert within the insulating member (16, 26) being placeable in a non-detachable preliminary locking position that permits the attachment of the connector contacts (13, 14) in a final locking position that holds the connector contacts (13, 14) in a non-releasable fashion;
wherein the insert (60, 80) at the front end (23, 33) of the insulating member (16, 26) is unlockable from its final locking position without destruction and from the front end (23, 33) can be axially returned to its preliminary locking position.

2. The plug connector as recited in claim 1, wherein:
the insert (60, 80) is provided with final locking hooks (71, 91) that are distributed over the periphery, and that engage counter locks (76, 96) that are provided at the rear within the front end (23, 33) of the insulating member (16, 26) and that are accessible from the exterior periphery of the insulating member (16, 26).

3. The plug connector as recited in claim 2, wherein:
the final locking hooks (71, 91) are elastically movable to be radially biased to the outside.

4. The plug connector as recited in claim 2, wherein:
the counter locks are formed by an edge area of a radial cutout (76, 96) within the front end of the insulating member (16, 26).

5. The plug connector as recited in claim 2, wherein:
the final locking hooks (71, 91) are provided on an axial bar (72, 92) which is molded on the interior end of the insert (60, 80).

6. The plug connector as recited claim 1, wherein:
the insert (60, 80) is provided with unmovable preliminary-locking cams (70, 90) that are arranged so as to be distributed over the periphery and that engage behind a limit stop (75, 95).

7. The plug connector as recited in as recited claim 1, wherein:
the final locking hooks (31, 91) and the preliminary-locking cams (70, 90) are separated from each other in the peripheral direction.

8. The plug connector as recited in claim 1, wherein an axial distance between the final locking hooks (71, 91) and the preliminary-locking cams (70, 90) is identical to the axial path of the insert (60, 80), where by to insert the preliminary-locking fingers (78, 98) on the insulating member (16, 26) into the facing ends (67, 87) of the through boreholes (65, 85) of the insert (60, 80).

9. The plug connector as recited in claim 1, wherein:
the through boreholes (65, 85) are configured to be stepped within the insert (60, 80).

10. The plug connector as recited in claim 9, wherein:
the larger-diameter, front end (67, 87), seen in the insertion direction, of the through borehole (65.85) of the insert (60, 80), surrounds the spreadable fingers (78, 98) in the final locking position, whereby both the through borehole (65, 85) as well as the fingers (78, 98) advantageously have conical or tapered segments that fit inside each other.

11. The plug connector as recited in claim 1, wherein the insert (60) at its front end (62), seen in the insertion direction, is provided with a peripheral seal (64).

12. The plug connector as recited in claim 1, wherein:
the insulating member (26) that is furnished with female connector contacts (14) at its front end (33) and at its rear end (27) are provided with an adjacent, peripheral seal (100) that is axially effective.

13. The plug connector as recited in claim 1, wherein the connector contact (13, 14) has a detent collar (39,49) and has a guiding collar (37,47) that has a smaller diameter than the detent collar and that is axially distanced from the former and that adjoins the contact end (36, 46).

14. The plug connector as recited in claim 1, wherein:
the connector contact (13, 14) has a first crimping end (41, 51) which holds an electrical conductor (41, 31) and has a second crimping end (42, 52), which holds a sealing sleeve (43, 53) around the conductor.
